(19) United States
(12) Patent Application Publication
(10) Pub. No.: US 2023/0350069 A1
(43) Pub. Date: Nov. 2, 2023

(54) METHOD FOR USING A LIDAR DEVICE WITH DESCRIPTORS

(71) Applicant: Continental Autonomous Mobility Germany GmbH, Ingolstadt (DE)

(72) Inventors: Thomas Meneyrol, Toulouse (FR); Laure Bajard, Toulouse (FR); Florian Don, Toulouse (FR)

(21) Appl. No.: 17/925,718

(22) PCT Filed: Jun. 11, 2021
(86) PCT No.: PCT/EP2021/065838

§ 371 Date: Nov. 16, 2022

(30) Foreign Application Priority Data
Jun. 11, 2020 (FR) FR2006095

(51) Int. Cl. G01S 17/931; G01S 17/89; G01S 17/50; G01S 7/48

(52) U.S. Cl. CPC G01S 17/931; G01S 17/89; G01S 17/50; G01S 7/4802

(57) ABSTRACT

A method for using a LIDAR device, includes determining a first descriptor having a first set of unique environment signatures for a selection of cells of the photodetector, with this first descriptor corresponding to a first sequence for receiving reflected light rays; determining a second descriptor having a second set of unique environment signatures for a selection of cells of the photodetector, with this second descriptor corresponding to a second sequence for receiving reflected light rays; identifying the environment signatures that are identical in the first descriptor and the second descriptor, with an environment signature of a particular cell of the photodetector being defined as a set of indicators each associated with a cell with a predetermined pattern of environment cells of the particular cell.

### CROSS REFERENCE TO RELATED APPLICATIONS

This application is the U.S. National Phase Application of PCT International Application No. PCT/EP2021/065838, filed Jun. 11, 2021, which claims priority to French Patent Application No. FR2006095, filed Jun. 11, 2020, the contents of such applications being incorporated by reference herein.

### FIELD OF THE INVENTION

The invention relates to the field of motor vehicles and more specifically relates to LIDAR devices employed in motor vehicles.

### BACKGROUND OF THE INVENTION

LIDAR (LIght Detection And Ranging) devices are devices that allow objects and other elements in the environment of a motor vehicle to be detected and the distance between the vehicle and the detected objects to be measured.

LIDAR devices employed in motor vehicles generally comprise a light emitter, which is designed to emit incident light rays, i.e., toward the environment of the vehicle. They also comprise a photodetector, which is designed to receive in return the light rays reflected by the objects located in the environment of the vehicle. By measuring the elapsed times between the emission and the reception of the light rays, and by taking into account the speed of propagation of light, LIDAR devices allow the objects surrounding the vehicle to be detected and the distance of these objects from the vehicle to be determined.

LIDAR devices are generally employed in motor vehicles to assist the driver, for example, in the case of certain maneuvers or to implement cruise control systems. LIDAR devices are also used in autonomous vehicles, i.e., vehicles capable of driving autonomously without a human driver. In particular, owing to their precision, LIDAR devices are indispensable in driving systems for autonomous vehicles and allow these vehicles to perceive their surroundings, which is a crucial operation to allow the vehicle to adapt its trajectory to the environment.

The reliability of a LIDAR device, when it is used in a motor vehicle, is a guarantee of safety. Moreover, when a LIDAR device is employed in an autonomous vehicle, this reliability is critical since the safety of the passengers and the environment of the vehicle is based on this reliability in particular.

LIDAR devices, when they are employed in a vehicle, allow successive sequences of the external environment to be detected and allow the same object present in these various sequences to be matched. The LIDAR device thus allows the vehicles to perceive the movements of the objects surrounding the vehicle, with these movements being linked to the relative movement of the vehicle and/or to the specific movement of these objects. Matching objects between various sequences detected by the LIDAR device thus allows the movement of an object from one sequence to another to be detected and quantified. This recognition of the movement is the basis of the use of LIDAR devices in motor vehicles, and more specifically in autonomous vehicles, in particular to ensure the safety of the vehicle and of its environment, by detecting, for example, any movement of an object and specifically those that could interfere with the vehicle.

LIDAR devices are known that are employed in motor vehicles and are provided with means for matching objects.

The LIDAR devices of the prior art generally determine a point cloud for each detected sequence of the environment, with these point clouds representing the environment of the vehicle at a given instant. For each of these point clouds, complex algorithms are generally employed to detect, within the point cloud, singularities called “key points”. After various key points are detected in the various sequences, these algorithms carry out identification computations allowing the presence of the same key point in the various sequences to be recognized.

The LIDAR devices of the prior art require significant computation resources for implementing these complex algorithms and also require the use of high-resolution photodetectors to enable precise and efficient detection of the key points.

In the LIDAR devices of the prior art, increasing performance and detection safety necessarily involves increasing the resolution of the photodetector and increasing the computation power.

### SUMMARY OF THE INVENTION

An aim of the invention is to improve the methods of the prior art.

To this end, an aim of the invention is a method for using a light detection and ranging (LIDAR) device in a motor vehicle, comprising the following steps:
emitting incident light rays from the motor vehicle toward its external environment;
receiving in return reflected light rays on a photodetector of the motor vehicle;
associating a value representing a quantity relating to the reflected light ray with each cell of the photodetector that receives a reflected light ray.

This method further comprises the following steps:
a step of determining a first descriptor comprising a first set of unique environment signatures for a selection of cells of the photodetector, with this first descriptor corresponding to a first sequence for receiving reflected light rays;
a step of determining a second descriptor comprising a second set of unique environment signatures for a selection of cells of the photodetector, with this second descriptor corresponding to a second sequence for receiving reflected light rays;
a step of identifying the environment signatures that are identical in the first descriptor and the second descriptor;
with an environment signature of a particular cell of the photodetector being defined as a set of indicators each associated with a cell with a predetermined pattern of environment cells of said particular cell.

The term “descriptor” in this case encompasses a unique descriptor or a list of descriptors.

Such a method for using a LIDAR device is based on simple operations that require limited computation resources. In addition, this method can be implemented with LIDAR devices provided with low resolution photodetectors, while ensuring maximum detection safety of the objects in the environment of the vehicle and the matching thereof in order to identify the movement of these objects.

An aspect of the invention counters the tendency to increase the resolution of the photodetectors and the computation resources, as encountered in the prior art, allowing detection to be improved in terms of performance and of safety, while reducing the resolution requirements of the photodetector as well as its computation power.

Indeed, an aspect of the invention is not based on complex operations for identifying “key points” in the sequences detected by the photodetector, but rather on a general characterization of these various sequences by virtue of the sets of unique environment signatures. The simple and unique character of the environment signatures forming the set of unique signatures considerably reduces the resources necessary for computing the matching step.

An aspect of the invention thus allows simple and robust LIDAR devices to be used that are provided with low resolution photodetectors. These LIDAR devices thus comply with automotive standards for low cost production and with a high reliability level, which was not the case with the LIDAR devices of the prior art, the footprint, the cost and the reliability level of which were not compatible with the automobile production standards.

The method according to an aspect of the invention can comprise the following additional features, alone or in combination:
during the step of determining the first descriptor, the selection of cells comprises only cells that are associated with a stand-off distance; and, during the step of determining the second descriptor, the selection of cells comprises only cells that are associated with a stand-off distance;
the first descriptor and the second descriptor are each determined by the following operations, executed sequentially for each particular cell of the selection of cells: a first operation of determining the environment signature of the particular cell; an operation of adding this environment signature of the particular cell to the set of unique environment signatures, if the set of unique environment signatures does not comprise any environment signature identical to this environment signature of the particular cell; an operation of deleting this environment signature from the particular cell, if the set of unique environment signatures already comprises an environment signature identical to this environment signature of the particular cell;
the predetermined pattern of environment cells, used to determine the environment signature of a particular cell, is made up of a predetermined number of cells framing this particular cell according to a predetermined pattern of a relative arrangement of the environment cells relative to the particular cell;
the set of indicators, used to determine the environment signature of a particular cell, is formed by a set of binary digits each assigned to a cell of the predetermined pattern of environment cells;
the binary digits are assigned to each cell of the predetermined pattern of environment cells of the particular cell, as follows: assigning a first binary digit to the environment cell if said cell is associated with a stand-off distance exhibiting a difference, relative to the stand-off distance associated with the particular cell, that is less than a predetermined value; assigning a second binary digit to the environment cell if said cell is associated with a stand-off distance exhibiting a difference, relative to the stand-off distance associated with the particular cell, that is greater than said predetermined value;
said predetermined value is equal, for example, for each environment cell, to a predetermined distance threshold multiplied by the distance separating this environment cell from the particular cell;
said predetermined value is equal, for each environment cell, to a distance threshold depending on the location of the particular cell on the sensor;
when the device receives, for the same reception sequence and on the same environment cell, several reflected light rays: the first binary digit is assigned to the environment cell if at least one of the received reflected light rays is associated with a stand-off distance exhibiting a difference, relative to the stand-off distance associated with the particular cell, that is less than said predetermined value; the second binary digit is assigned to the environment cell if all the received reflected light rays are associated with a stand-off distance exhibiting a difference, relative to the stand-off distance associated with the particular cell, that is greater than said predetermined value;
the signatures of environments, each associated with a cell of the predetermined pattern of environment cells, are each arranged as a word made up of the binary digits arranged in a predetermined order relative to the predetermined pattern of environment cells;
the method further comprises a step of filtering the first descriptor and a step of filtering the second descriptor, with these filtering steps comprising an operation of deleting the environment signatures that comprise a number of first binary digits or of second binary digits that is greater than a predetermined threshold;
the cells adjacent to the edges of the photodetector are excluded from the selection of cells during the step of determining the first descriptor, and during the step of determining the second descriptor;
the identification step comprises determining a list of identical environment signatures in the first descriptor and the second descriptor, which associates the relevant particular cell in the first and in the second sequence with each of these identical environment signatures;
during the step of associating a value representing a quantity relating to the reflected light ray with each cell of the photodetector that receives a reflected light ray, the representative value is a stand-off distance, with the stand-off distance being defined as a value representing the distance between the cell and an object returning said reflected light ray.

### BRIEF DESCRIPTION OF THE DRAWINGS

Other features and advantages of aspects of the invention will become apparent from the following non-limiting description, with reference to the appended drawings, in which:

FIG. 1 illustrates the steps of the method according to an aspect of the invention;

FIG. 2 illustrates the steps of generating a descriptor within the method of FIG. 1;

FIG. 3 schematically shows a portion of a photodetector of the LIDAR device used by the method according to an aspect of the invention;

FIG. 4 illustrates the generation of an environment signature according to an aspect of the invention;

FIG. 5 schematically shows an environment signature according to an aspect of the invention;

FIG. 6 is similar to FIG. 3 for a first variant;

FIG. 7 is similar to FIG. 3 for a second variant.

### DETAILED DESCRIPTION OF THE PREFERRED EMBODIMENTS

The method according to an aspect of the invention allows a LIDAR device to be used in a motor vehicle to perceive the environment of the vehicle by detecting an optical flow identifying the movement of the objects in the environment of the vehicle. This method can be implemented with a low resolution LIDAR device that is provided with basic computation means. This low resolution is, for example, 128×32 cells for the photodetector of the LIDAR device. The photodetectors generally comprise a photosensitive plate formed by an array of elementary sensors, made up of photodiodes, for example. Each cell of the photodetector, also called “pixel”, forms an elementary detection element.

In addition to this low resolution of 128×32 cells, the photodetector can also comprise a wide-angle lens, with each cell of the photodetector thus detecting the light rays corresponding to a large surface in the image of the environment of the vehicle (for example, from 1 to 3 m², 20 m away from the vehicle, per cell of the photodetector).

The constitution of a LIDAR device is known per se and will not be described in further detail herein. It simply should be noted that a LIDAR device comprises a light source designed to emit light pulses toward the environment of the vehicle, and a photodetector formed by an array of elementary cells designed to receive and detect the light rays reflected on the objects surrounding the vehicle, so as to determine a point cloud associating, for example, a stand-off distance from each object in the environment.

The method is thus initially used with the conventional steps of operating a LIDAR device:
emitting incident light rays from the motor vehicle toward its external environment;
receiving in return reflected light rays on a photodetector of the motor vehicle;
associating a value representing a quantity relating to the reflected light ray with each cell of the photodetector that receives a reflected light ray.

In the examples described herein, the value representing a quantity relating to the reflected light ray is a stand-off distance, which is defined as a value representing the distance between the cell and an object returning said reflected light ray. Alternatively, this value representing a quantity relating to the reflected light ray can be, for example, the intensity of the reflection, the reflectivity of the surface of an object, or any other quantity that can be detected by the LIDAR device.

The stand-off distance is computed by the LIDAR device based on the travel time of each light ray starting in the form of an incident ray and returning, after reflection on an object, in the form of a reflected ray. The stand-off distance corresponds to the distance between this object and the cell of the photodetector receiving the reflected light ray.

The LIDAR device thus has successive sequences, in which a light pulse is emitted and then collected by the photodetector. These successive sequences correspond to photos of the environment. The sequence of these successive sequences forms an optical flow. The method allows the movements in the successive sequences to be identified, so that the movement of objects, for example, between the various sequences can be analyzed and quantified in order to allow, in the present example, an autonomous vehicle to perceive its external environment and to adapt its driving thereto.

To this end, the method will consider each of the sequences of the optical flow separately, and will compare these sequences in pairs in order to evaluate the movements between two consecutive sequences.

In the present example, the implementation of the method will be described simply for two successive sequences, with it being understood that this elementary method can be implemented continuously for all the successive sequences forming an optical flow.

FIG. 1 schematically illustrates the implementation of the method for two successive sequences, i.e., for two environment images each producing a point cloud relating to the objects outside the vehicle.

In FIG. 1, the LIDAR device 1 is schematically shown as containing the various steps of the method. The rectangle S1 corresponds to a first sequence, in which the LIDAR device 1 acquires a point cloud corresponding to a first scene of the environment of the vehicle. The rectangle S2 for its part corresponds to the acquisition of a second sequence immediately following the acquisition of the first sequence S1.

Following the acquisition of the second sequence S2, the LIDAR device 1 thus has two point clouds, each corresponding to the image of a sequence S1, S2.

The aim of the method is to detect the movements performed between the sequence S1 and the sequence S2. This evolution between the sequence S1 and the sequence S2 will allow the movements seen from the vehicle to be determined.

According to FIG. 1, the data originating from the first sequence S1 will initially undergo a step of determining a first descriptor D1, then of filtering F1 this descriptor D1. The data originating from the second sequence S2 also undergoes the same processing involving determining a second descriptor D2 and filtering F2 this descriptor.

The method then performs, on the basis of these two filtered descriptors, a step of matching M, then of filtering FM this matching. These filtered matches C then can be used by the LIDAR device, or other elements for controlling the autonomous vehicle, to enhance the detection of the objects, for example, or to be able to analyze its own movement or the movements of the objects identified by another method.

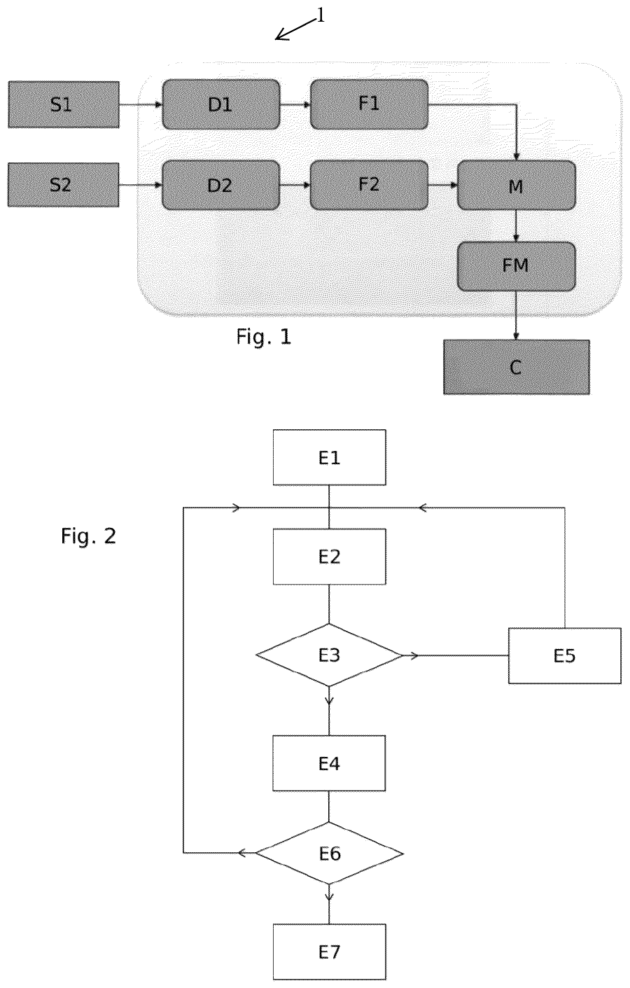

FIG. 2 is a diagram illustrating the steps of determining a descriptor D1, D2 for each of the sequences S1, S2 in further detail.

During the step of determining a descriptor, on the basis of the point cloud corresponding to a sequence S1, S2, the method will initially identify the usable cells of the photodetector (step E1). In this case, the usable cells of the photodetector are defined as the cells that actually received a light ray reflected by the presence of an object in the external environment. The cells of the photodetector that do not receive a reflected light ray do not detect the presence of an object and in this case are excluded from the cells considered to be usable. This is the case when the incident light ray does not find an object on its path and, since it is not reflected, therefore does not return to the photodetector. Similarly, an external method may have marked certain cells as unusable for various reasons, such as identifying a defect in the cell. Determining a descriptor D1, D2 thus applies only to the cells of the photodetector that have received a reflected light ray and/or that have not been marked as unusable by any external method. These usable cells form a selection of cells of the photodetector.

In the following step E2, the method determines an environment signature for one of the cells of the selection. The method returns to this step E2 so that this step E2 and the following steps are sequentially applied to each of the cells of the selection. Furthermore, the selection of cells can be limited to the usable cells that are not located on the edge of the plate of the photodetector.

Preferably, the usable cells forming the selection, which therefore will each undergo the steps E2 and the following steps, can be processed in order, for example, starting with the cell in the upper left end of the plate of the photodetector, then continuing, for each iteration of step E2 and the following steps, with a neighboring cell.

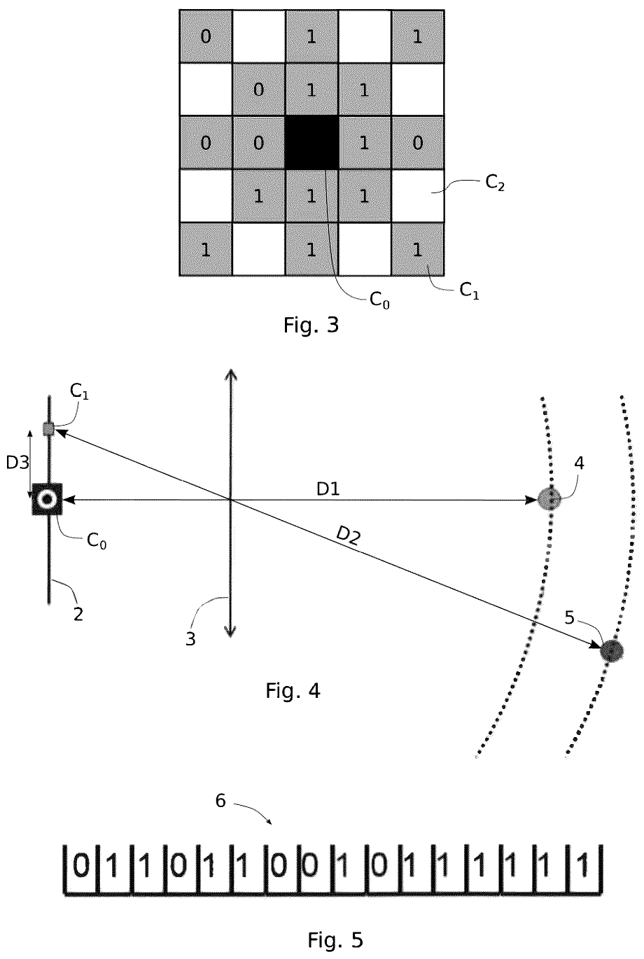

Step E2 is initially carried out for a first cell of the selection. Determining an environment signature for this first cell in this case involves assigning a binary digit to each of the cells that surround said cell according to a predetermined pattern. In order to simplify the vocabulary of the present application, the cell for which an environment signature is being determined is called, throughout the present application, “particular cell” and the cells surrounding a particular cell according to a predetermined pattern are called “environment cells”. Determining an environment signature will be described in further detail hereafter with reference to FIGS. 3 to 7.

On completion of step E2, a signature made up of a series of binary digits relating to the environment cells of the particular cell is therefore obtained by this iteration of step E2.

The method then proceeds to a step E3, in which it determines whether an environment signature identical to the environment signature that has just been determined in step E2 already exists in a list forming a set of unique signatures. With regard to the first iteration of step E2, i.e., of the first considered particular cell, no environment signature has been previously recorded, and the environment signature of this iteration is therefore necessarily added (step E4) to all the unique environment signatures. If, in the subsequent iterations of the steps E2 and of the following steps, targeting the following cells of the selection, a new environment signature is identified as identical to a signature already present in the set of unique environment signatures, the new signature in question is then deleted in step E5 and the method once again returns to step E2 in order to proceed with a new iteration with the next cell of the selection.

After the step E4 of adding a new signature to the set of unique signatures, the method proceeds to step E6, which determines whether the last cell of the selection has been reached. Step E6 thus determines whether all the cells of the selection have definitely undergone an iteration of the steps E2 and of the following steps. If, during step E6, the cell in question is not the last cell of the selection, the method returns to step E2, which is then implemented for the following cell.

If, during step E6, the cell in question is indeed the last cell of the selection, this means that the iterations of the steps E2 and of the following steps were carried out for the entire selection and the method then proceeds to step E7, in which the list of unique signatures is produced. As a new signature is only added to the list of unique signatures if no identical signature is already present (step E4) in the list, the method then has, in step E7, a set of signatures that are each unique, i.e., no signature is identical to another within the set of unique signatures.

Determining the environment signature of a particular cell (step E2) will now be described in further detail with reference to FIGS. 3 and 4.

FIG. 3 shows a portion of the matrix plate forming the photodetector. This matrix is made up of elementary photosensitive cells (also called “pixels”). On the portion illustrated in FIG. 3, a central cell C₀ is shown surrounded by other cells C₁ (shown in grey) and C₂ (shown in white). In this example, the cell C₀ is the particular cell for which an environment signature is being determined.

The grey cells C₁ are cells of the environment of the cell C_{0,} i.e., cells arranged in a predetermined pattern (visible in grey) around the particular cell C₀. The cells C₂ in white are not taken into account for determining the signature of the particular cell C₀.

Determining the environment signature of the particular cell Co will involve assigning a binary digit to each of the cells C₁ of the pattern. The other cells, such as the cells C₂ shown in white in FIG. 3, as well as all the other cells of the photodetector (which are not shown on the photodetector portion visible in FIG. 3) are not taken into account for determining the environment signature of the particular cell C₀.

In order to determine which binary digit is to be assigned to an environment cell C₁-, the principle involves, in the present example:
assigning the binary digit 0 if the stand-off distance associated with this environment cell C₁ is not close to the stand-off distance associated with the particular cell C₀;
assigning the binary digit 1 if the stand-off distance associated with this environment cell C₁ is close to the stand-off distance associated with the particular cell C₀.

In the illustrative example of FIG. 3, the binary digit associated with each of the environment cells C₁ has been schematically shown in each relevant cell C₁.

FIG. 4 schematically illustrates the criterion for determining the binary digit assigned to each of the environment cells C₁ when determining a signature for a particular cell C₀. FIG. 4 illustrates the plate 2 of the photodetector (schematically shown in profile form), the optical lens 3 of the photodetector, and schematically shows the environment of the vehicle according to a simple example where two objects 4, 5 are present in the environment.

FIG. 4 schematically shows, on the plate 2 of the photodetector, the particular cell C₀ and the environment cell C₁ for which a binary digit is being determined. In this example, the cell C₀ is associated with a stand-off distance D1 corresponding to the distance between the cell C₀ and the object 4, and the environment cell C₁ is associated with a stand-off distance D2 corresponding to the distance between the cell C₁ and the object 5.

The binary digit 0 will be assigned to the cell C₁ if the difference D2-D1 is greater than a predetermined threshold. The binary digit 1 will be assigned to the cell C₁ if the difference D2-D1 is less than a predetermined threshold.

This predetermined threshold can be a fixed threshold, for example, 50 centimeters. As a variant, this predetermined threshold can be a threshold adjusted as a function of the position of the cell C₁ on the plate 2. In this case, the difference D2-D1 will be compared with a predetermined distance multiplied by the distance D3 that separates the cell C₀ from the cell C₁ on the plate 2. It is also possible to use a predetermined threshold depending on the position of C₀ to be used with the various variants presented above.

According to one embodiment, the method is implemented with a LIDAR device that is adapted for identifying several layers of reflected rays. These known LIDAR devices, called multi-layer LIDAR devices, allow several light rays to be acquired that are reflected on the same cell of the photodetector, for the same sequence, which allows the reflection phenomena to be taken into account. For example, when the LIDAR device emits incident light rays toward a semi-reflective pane, fog, or any other element causing partial reflection of the light rays, the photodetector of the LIDAR device receives a first light ray reflected by the semi-reflecting element, then possibly receives other light rays reflected by the objects located behind the semi-reflecting element and also reflecting the incident light ray. In these multilayer LIDAR devices, each cell of the photodetector is then associated with several stand-off distances (generally up to 4). In this case, when assigning a binary digit to an environment cell C₁, all the stand-off distances associated with this cell will be considered. If at least one of the distances D2 associated with this cell C₁ verifies the condition set forth above (difference D2-D1 below a predetermined threshold), then the binary digit 1 is assigned to the environment cell C₁. It is only when all the stand-off distances D2 associated with this cell C₁ do not verify the condition (i.e., when the difference D2-D1 is above the predetermined threshold for all the distances D2) that the binary digit 0 is assigned to the environment cell C₁.

When a binary digit has been assigned to each of the environment cells C₁ of the predetermined pattern (visible in grey in FIG. 3), the method then determines a binary word that comprises all the binary digits of all the environment cells C₁ corresponding to a particular cell C₀.

An example of this binary word 6 is shown in FIG. 5, this number corresponds to the example of the binary digits assigned to each of the cells C₁ in FIG. 3 read from left to right and from top to bottom. The binary word 6 illustrated in FIG. 5 is a 16 bit binary word (with the predetermined pattern provided as an example in FIG. 3 comprising 16 environment cells C₁ evenly distributed around the particular cell C₀). This 16 bit word 6 forms the environment signature of the particular cell C₀.

In the present example, the method also comprises a filtering operation (operations F1, F2 of FIG. 1), in which certain environment signatures 6 are ignored on the basis of coherence criteria. These coherence criteria are preferably simple in order to guarantee a high speed of execution of the method and low required computation resources. These coherence criteria involve, for example, ignoring all the signatures 6 that comprise an abnormally high number of the same binary digit. For the example of the 16 bit binary word 6 of FIG. 5, any signature comprising, for example, more than 12 times the same binary digit 0 or the same binary digit 1, will be ignored and will not be included in the set of unique environment signatures. The set of signatures thus not only comprises signatures 6 that are each unique, but which also have a particular feature that is provided by the coherence criterion.

With reference to FIG. 1, during the matching step M, the set of unique environment signatures corresponding to a first sequence S1 is compared with the set of unique signatures corresponding to the second sequence S2. Each signature 6 of a sequence that is identical to a signature 6 of the other sequence will be identified as a movement of the sequence S1 to the other sequence S2.

In the present example, the method also comprises a filtering step FM (see FIG. 1), which involves filtering, according to coherence criteria, the signatures 6 identified as present both in the sequence S1 and in the sequence S2. As previously, these coherence criteria are preferably simple. They can relate, for example, to the notion of optical flow, starting from the principle that the objects surrounding the vehicle can only move at speeds below a predetermined threshold. For example, if two identical signatures, one in sequence S1 and the other in sequence S2, are identified as relating to a movement between sequence S1 and sequence S2 that reveals a high speed, for example, at 300 km/hour, this identified match will be ignored.

In the final step C, (FIG. 1) the method thus provides a filtered list of the particular cells C₀ with environment signatures 6 that are identical from one sequence S1 to the other sequence S2. The LIDAR device thus has a value representing a movement in its environment.

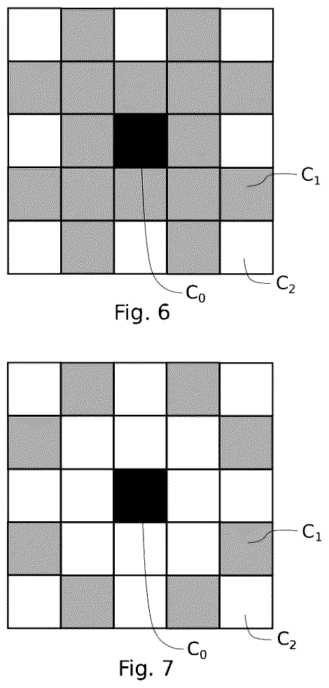

Alternative embodiments of the method can be implemented without departing from the scope of the invention. For example, FIGS. 6 and 7 provide two other illustrative examples of predetermined patterns that can be applied around a particular cell C₀ for determining its environment signature.

FIG. 6 illustrates a predetermined pattern returning a 16 bit binary word, yet from a different arrangement of the environment cells C₂. FIG. 7, for its part, illustrates the use of a predetermined pattern of 8 cells returning an 8 bit environment signature.

1. A method for using a light detection and ranging (LIDAR) device in a motor vehicle, the method comprising:
emitting incident light rays from the motor vehicle toward its external environment;
receiving in return reflected light rays on a photodetector of the motor vehicle;
associating a value representing a quantity relating to the reflected light ray with each cell of the photodetector that receives a reflected light ray;
determining a first descriptor comprising a first set of unique environment signatures for a selection of cells of the photodetector, with this first descriptor corresponding to a first sequence for receiving reflected light rays;
determining a second descriptor comprising a second set of unique environment signatures for a selection of cells of the photodetector, with this second descriptor corresponding to a second sequence for receiving reflected light rays; and
identifying the environment signatures that are identical in the first descriptor and the second descriptor;
with an environment signature of a particular cell of the photodetector being defined as a set of indicators each associated with a cell with a predetermined pattern of environment cells of said particular cell.

2. The method as claimed in claim 1, wherein, during the determining the first descriptor, the selection of cells comprises only cells that are associated with a stand-off distance; and, during the determining the second descriptor, the selection of cells comprises only cells that are associated with a stand-off distance.

3. The method as claimed in claim 1, wherein the first descriptor and the second descriptor are each determined by the following operations, executed sequentially for each particular cell of the selection of cells:
a first operation of determining the environment signature of the particular cell;
an operation of adding this environment signature of the particular cell (C₀) to the set of unique environment signatures, if the set of unique environment signatures does not comprise any environment signature identical to this environment signature of the particular cell;
an operation of deleting this environment signature from the particular cell, if the set of unique environment signatures already comprises an environment signature identical to this environment signature of the particular cell.

4. The method as claimed in claim 1, wherein the predetermined pattern of environment cells, used to determine the environment signature of a particular cell, is made up of a predetermined number of cells framing this particular cell according to a predetermined pattern of a relative arrangement of the environment cells relative to the particular cell.

5. The method as claimed in claim 1, wherein the set of indicators, used to determine the environment signature of a particular cell, is formed by a set of binary digits each assigned to a cell of the predetermined pattern of environment cells.

6. The method as claimed in claim 5, wherein the binary digits are assigned to each cell of the predetermined pattern of environment cells of the particular cell, as follows:
assigning a first binary digit to the environment cell if said cell is associated with a stand-off distance exhibiting a difference, relative to the stand-off distance associated with the particular cell, that is less than a predetermined value; and
assigning a second binary digit to the environment cell if said cell is associated with a stand-off distance exhibiting a difference, relative to the stand-off distance associated with the particular cell, that is greater than said predetermined value.

7. The method as claimed in claim 6, wherein said predetermined value is equal, for each environment cell, to a predetermined distance threshold multiplied by the distance separating this environment cell from the particular cell.

8. The method as claimed in claim 6, wherein said predetermined value is equal, for each environment cell, to a distance threshold depending on the location of the particular cell on the sensor.

9. The method as claimed in claim 6, wherein, when the device receives, for the same reception sequence and on the same environment, several reflected light rays:
the first binary digit is assigned to the environment cell if at least one of the received reflected light rays is associated with a stand-off distance exhibiting a difference, relative to the stand-off distance associated with the particular cell (C₀), that is less than said predetermined value;
the second binary digit is assigned to the environment cell if all the received reflected light rays are associated with a stand-off distance exhibiting a difference, relative to the stand-off distance associated with the particular cell, that is greater than said predetermined value.

10. The method as claimed in claim 5, wherein the signatures of environments, each associated with a cell of the predetermined pattern of environment cells, are each arranged as a word made up of the binary digits arranged in a predetermined order relative to the predetermined pattern of environment cells.

11. The method as claimed in claim 5, further comprising filtering the first descriptor and filtering the second descriptor, with these filtering steps comprising an operation of deleting the environment signatures that comprise a number of first binary digits or of second binary digits that is greater than a predetermined threshold.

12. The method as claimed in claim 1, wherein the cells adjacent to the edges of the photodetector are excluded from the selection of cells during the determining the first descriptor, and during the determining the second descriptor.

13. The method as claimed in claim 1, wherein the identification comprises determining a list of identical environment signatures in the first descriptor and the second descriptor, which associates the relevant particular cell in the first and in the second sequence with each of these identical environment signatures.

14. The method as claimed in claim 1, wherein, during the associating a value representing a quantity relating to the reflected light ray with each cell of the photodetector that receives a reflected light ray, the representative value is a stand-off distance, with the stand-off distance being defined as a value representing the distance between the cell and an object returning said reflected light ray.

15. The method as claimed in claim 7, wherein said predetermined value is equal, for each environment cell, to a distance threshold depending on the location of the particular cell on the sensor.
